(19) United States
(12) Patent Application Publication
(10) Pub. No.: US 2011/0155253 A1
(43) Pub. Date: Jun. 30, 2011

(54) Biodegradable eyewear for stereoscopic image viewing

(76) Inventors: Lenny Lipton, Los Angeles, CA (US); Marty Shindler, Encino, CA (US)

(21) Appl. No.: 12/930,233

(22) Filed: Dec. 29, 2010

Related U.S. Application Data
(60) Provisional application No. 61/335,088, filed on Dec. 31, 2009.

(51) Int. Cl. G02B 27/22

(52) U.S. Cl. 137/1; 359/464

(57) ABSTRACT

A stereoscopic image receiving device is provided. The device includes a front frame piece configured to maintain two stereoscopic lenses, the front piece substantially constructed of biodegradable materials. The device further includes a pair of temple pieces, each temple piece connectable to the front frame piece at an end thereof, each temple piece substantially constructed of biodegradable materials.

This application claims the benefit of U.S. Provisional Patent Application Ser. No. 61/335,088, entitled “Biodegradable Eyewear for Stereoscopic Image Viewing”, inventors Marty Shindler et al., filed on Dec. 31, 2009, the entirety of which is incorporated herein by reference.

### BACKGROUND OF THE INVENTION

1. Field of the Invention

The present invention relates to optical selection devices or glasses used to view stereoscopic images.

2. Description of the Related Art

3-D glasses or eyewear allow a user to view stereoscopic motion pictures and typically incorporate temple-pieces and frames. Each member of the viewing audience must wear 3-D eyewear in order to achieve image selection. Image selection affords the viewer's left eye to see the left image while the right eye image is blocked, and vice versa.

In a movie theater setting, a user is provided with glasses, typically either disposable or reusable. Disposable eyewear in the past has been formed of paper with lenses provided with lenses either sandwiched between sheets of paper or cardboard stock, and such materials can be retained by the user/wearer and thrown away, either at the exit of the theater or elsewhere. In some instances, disposable eyewear can be collected and reused.

Reusable eyewear is typically formed of some type of plastic with polarizing lens material held by the plastic, such as located within a groove formed within the plastic. Such plastic eyewear is manufactured using an injection molding processes They are typically distributed with each ticket sold to a 3D movie. After the movie, the reusable eyewear are collected by theater employees or can be placed in a recycle bin provided at or near at least one exit of the theater. Users return the reusable eyewear in the bin and the reusable eyewear may be cleaned, and provided to subsequent theater patrons. However, in certain instances, the eyewear can become damaged or otherwise unacceptable, at which time the glasses are typically discarded or in certain instances recycled at a plastic recycling facility.

The total number of eyewear units per year is currently estimated to be in the range of 250 to 500 million on a global basis, dominated by plastic single use versions. Demand for eyewear is increasing each year as more 3D stereoscopic theaters are built around the world and as more movies are produced and released in 3D.

In the case of plastic, which is used in the majority of movie theater glasses, used eyewear is sometimes ground up and used in various applications. Used paper/cardboard glasses are sent to recycling centers. However, whether disposable or reusable, much of the eyewear can end up in a landfill or other trash site. With environmental concerns, simply disposing of disposable or reusable eyewear is discouraged as such disposal is harmful to the environment.

Further, currently available plastic reusable eyewear is made from petroleum based products, a resource that is not renewable, thus providing further harm to the environment.

Thus it would be advantageous to offer a stereoscopic eyewear design that provides high visual quality, user comfort and ease of use, and is more environmentally acceptable than designs previously available.

### BRIEF DESCRIPTION OF THE DRAWINGS

FIG. 1 is an illustration of biodegradable stereoscopic eyewear in accordance with the present design;

FIG. 2 shows a process for recycling biodegradable stereoscopic eyewear according to one aspect of the present design; and

FIG. 3 illustrates one embodiment of the present design.

### DETAILED DESCRIPTION OF THE INVENTION

The present design comprises a set of 3D eyewear formed from biodegradable materials. Materials that may be employed include compostable materials and/or renewable earth friendly plastic-like materials. Such materials may come from plants such as alfalfa, beets, corn, potato skins, switch grass and wheat, all renewable resources.

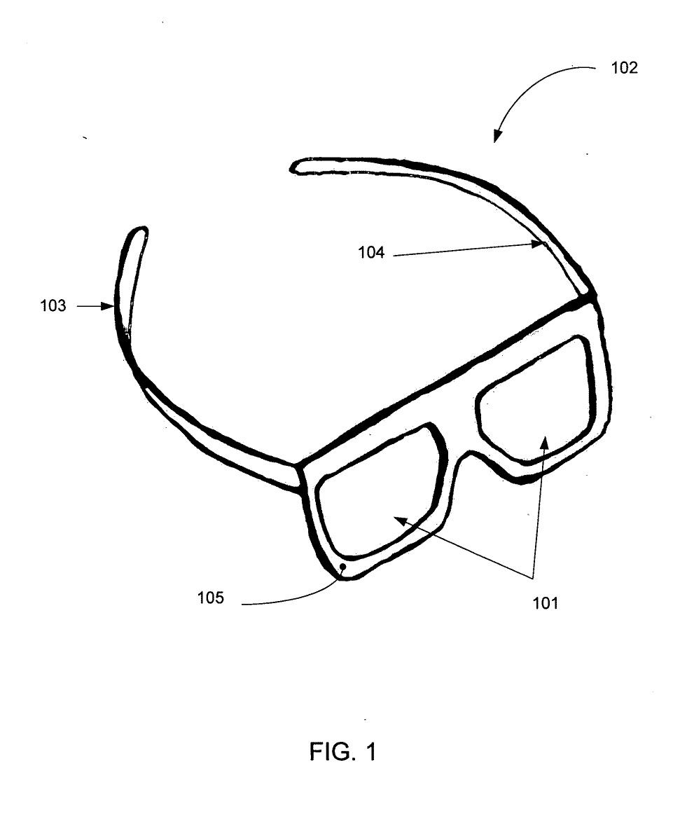

A physical representation of glasses formed in this manner is presented in FIG. 1. As will be discussed, lenses may be employed in a manner that enables easy release but such easy release functionality is not required. The reason for this that while the frames may be formed of biodegradable material, as of the present time polarizing lenses cannot be formed of biodegradable materials. While this may change in the future, there is currently no generally known biodegradable material that can be employed in polarized lenses sufficient for viewing 3D movies. Thus the lenses 101 may be separated from the frames 102 in the current design, such that the biodegradable frame degrades and does not harm the environment and/or remain in a landfill. Frames 102 comprise temple pieces 103 and 104 and frame piece 105. Removed lenses may be ground up and disposed of, with the net result being a lower amount of nonbiodegradable material.

The present design may be manufactured using renewable energy. For example, the frames 102 may be formed using injection molding of biodegradable materials using energy generated from natural resources such as sunlight, wind, rain, ocean, and geothermal sources.

The present design may include frames 102 formed from Cereplast, or Cereplast Compostables®, currently available from Cereplast, Inc., of Hawthorne, Calif. Cereplast Compostable resins are renewable, ecologically sound substitutes for petroleum-based plastic product, replacing nearly 100% of the petroleum-based additives used in traditional plastics. Cereplast Compostable resins use polymer and additives derived from starch and other renewable resources chemistry. These components are carefully blended together.

Reference is specifically made to U.S. Pat. No. 7,138,439, inventors Frederic Scheer, et al., issued Nov. 21, 2006, and U.S. Pat. No. 7,393,590, inventors Frederic Scheer, et al., issued Jul. 1, 2008, the entirety of which are incorporated herein by reference.

The biodegradable material comprises between 40 and 97% by weight of poly(lactic acid) polymer, between 0.5 and 35% by weight of co-polyester polymer with adipic acid, and between 2% and 20% magnesium silicate, each on the basis of the total weight of the biodegradable composition.

### Cereplast

From U.S. Pat. No. 7,138,439, the material employed as one biodegradable option is a plastic designed to undergo a significant change in its chemical structure under specific environmental conditions, resulting in a loss of some properties that may be measured by standard tests methods appropriate to the plastic and the application in a period of time that determines its classification. The time period required for a degradation will vary and may also be controlled when desired. Generally, the time span for biodegradation will be significantly shorter than the time span required for a degradation of objects made from conventional plastic materials having the same dimensions, such as e.g. polyethylene, which have been designed to last for as long as possible. For example, cellulose and Kraft paper is to biodegrade within 83 days in a compost environment. The present formulation is to biodegrade in a shorter period of time and is said to pass tests required by ASTM 6400 D99, which demand that compostable plastic would biodegrade within less than 180 days.

Biodegradable polymers are comprised of components which are reduced in film or fiber strength by microbial catalyzed degradation. The biodegradable polymers are reduced to monomers or short chains, which are then assimilated by the microbes. In an aerobic environment, these monomers or short chains are ultimately oxidized to CO₂, H₂O, and new cell biomass. In an anaerobic environment the monomers or short chains are ultimately oxidized to CO₂, H₂O, acetate, methane, and cell biomass. Successful biodegradation requires direct physical contact between the biodegradable polymers and the active microbial population or the enzymes produced by the active microbial population. Moreover, certain minimal physical and chemical requirements such as suitable pH, temperature, oxygen concentration, proper nutrients, and moisture level are required. (cf. U.S. Pat. No. 6,020,393).

A biodegradable composition according to the Cereplast design comprises between 40% by weight to 97% by weight of poly(lactic acid) polymer, between 0.5% by weight to 35% by weight of co-polyester polymer with adipic acid, and between 1 and 32, preferably 2% and 20% magnesium silicate, each on the basis of the total weight of the biodegradable composition.

A composition according to the present design may be obtained by mixing or blending the respective constituents in the desired amounts. This may be performed according to any method known in by the skilled artisan. For example, poly(lactic acid) polymer and co-polyester polymer with adipic acid may be mixed in pure form, for example blended by means of mill roll blending, and heated to a temperature chosen according to the general knowledge in the art such that at least one of the above-mentioned components is partially or essentially completely molten.

Poly(lactic acid) may be represented by the following structure:

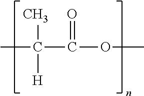

wherein n for example can be an integer between 10 and 250. Poly(lactic acid) can be prepared according to any method known in the state of the art. For example, poly(lactic acid) can be prepared from lactic acid and/or from one or more of D-lactide (i.e. a dilactone, or a cyclic dimer of D-lactic acid), L-lactide (i.e. a dilactone, or a cyclic dimer of L-lactic acid), meso D,L-lactide (i.e. a cyclic dimer of D-, and L-lactic acid), and racemic D,L-lactide (racemic D,L-lactide comprises a 1/1 mixture of D-, and L-lactide).

The preparation of polyesters and copolyesters is well known in the art, such as disclosed in U.S. Pat. No. 2,012,267. Such reactions are typically operated at temperatures from 150° C. to 300° C. in the presence of polycondensation catalysts such as titanium isopropoxide, manganese diacetate, antimony oxide, dibutyl tin diacetate, zinc chloride, or combinations thereof. The catalysts are typically employed in amounts between 10 to 1000 parts per million (ppm), based on total weight of the reactants (cf. U.S. Pat. No. 6,020,393).

In addition to the Poly(lactic acid) and a copolyester, the composition is compounded with a mineral, comprising magnesium, and/or silicate.

According to another approach, a composition according to the present application may be obtained by mixing the respective amounts of poly(lactic acid) polymer precursors and of co-polyester polymer with adipic acid or respective amounts of a poly(lactic acid) polymer and of precursors of co-polyester polymer with adipic acid with or without a solvent and subjecting the resulting mixture to a polymerization reaction. Poly(lactic acid) polymer precursors are for example lactic acid, cyclic or linear oligomers of lactic acid resulting from condensation reactions of two to fifty lactic acid units, such as e.g. the above-mentioned lactides, and may have any stereo configuration. Compositions made from other poly(lactic acid) polymer precursors and/or precursors of co-polyester polymer with adipic acid may also be used according to the general knowledge of a skilled person in the art.

In particular, a biodegradable composition according to the present design may comprise between 50 and 85% by weight of poly(lactic acid) polymer, and especially between 55 and 82% by weight of poly(lactic acid) polymer, in particular between 2 and 20% by weight of co-polyester polymer with adipic acid, and especially between 4 and 17% by weight of co-polyester polymer with adipic acid, each on the basis of the total weight of the biodegradable composition.

The biodegradable polymer further comprises between 1 and 32%, preferably between 2% and 25%, more preferably between 5% and 15% by weight of mineral particles, each on the basis of the total weight of the biodegradable composition, said mineral particles comprising at least one of magnesium, and silicate, preferably comprising at least two elements selected from the group consisting of magnesium, and silicate, more preferably comprising magnesium, and silicate. Examples for such minerals are e.g. montmorillonite. The Mineral seems to act as filler, adds strength and imparts stiffness. For example, the mineral particles can have a size of 0.2. to 4.0 μm, more preferably of 1 to 2 μm, most preferably of 1 to μm.

Moreover, during the preparation of a biodegradable polymer according to the present design, an organic peroxide may be added to the reaction mixture in an amount of less than 5% by weight, on the basis of the total weight of the biodegradable final polymer composition.

Examples for organic peroxides which may be used for preparing a composition are e.g. diacetyl peroxide, cumyl-hydroperoxide, and dibenzoyl peroxide. Other organic peroxides known to a skilled person may be used as well. The organic peroxides serve as radical starter molecules initiating a polymerization and help to provide connections, in particular covalent bonds, between the components present in a composition according to the present design.

Preferably less than 2% of an organic peroxide, more preferably between 0.1% and 1.8%, even more preferred about 1% of an organic peroxide, each on the basis of the total weight of the final biodegradable composition, is added to the reaction mixture for producing the biodegradable polymer composition according to the present invention.

A biodegradable polymer composition useful in the present design may also comprise between 5 and 45% by weight of poly(epsilon caprolactone), on the basis of the total weight of the biodegradable composition. Preferably, a composition may comprise between 20 and 40% by weight of poly(epsilon caprolactone, more preferably between 21 and 35% by weight of poly(epsilon caprolactone), on the basis of the total weight of the biodegradable final polymer composition. In particular, an addition of poly(epsilon caprolactone) provides advantages when film or coatings are prepared according to the present invention. PCL will add improved flexibility and allow one to make a clearer, more transparent film.

Moreover, a biodegradable polymer composition may further comprise up to 5% of a mono ester, more preferably between 0.1 and 4.5% by weight of a mono ester, on the basis of the total weight of the biodegradable composition. The mono-ester may be a carboxylic acid, a sulfonic acid or a phosphoric acid having e.g. between 2 and 20 carbon atoms and comprising aliphatic (having branched or linear chains) and/or aromatic structural units. In particular, the mono ester can be a mono ester of a compound comprising at least two carboxyl groups and/or may be for example chosen from the group consisting of adipic acid and lactic acid. In particular, an addition of a mono ester can be useful when formulating injection molding formulations. This serves as a processing aid and will protect polymers from thermo-abuse.

Additionally, a biodegradable polymer composition can also comprise one or more plasticizers. A plasticizer as used in a composition, as well as the resulting products, should be preferably associated with essentially no or only low environmental risks, such that upon degradation of a composition of the present invention the respective site where the degradation takes place will not or essentially not be polluted. Plasticizers for use in a composition according to the present design can therefore be for example naturally occurring compounds. Examples for plasticizers are e.g. organic citrate esters (cf. U.S. Pat. No. 5,556,905).

A biodegradable polymer composition of the present invention may also comprise additional additives or components well known in the art, such as e.g. natural coloring agents, additional polymeric compounds, cellulose, etc.

In addition, a composition according to the present invention may also be applied on a carrier material, such as e.g. paper, composite material, plastics, metal, wood, etc.

While it is contemplated that the biodegradable eyewear disclosed herein is to be substantially composed of biodegradable materials, such as Ceraplast, non-biodegradable materials may be employed, either intentionally or unintentionally. It is intended that a predominant portion of the eyewear comprises biodegradable materials, where such a predominant portion comprises half or more of the materials employed. Certain entities may, for cost reasons, use reasons, and/or other reasons, wish to employ alternate materials in the frames, but the current intent is that as much biodegradable material as possible is employed in the eyewear.

A composition of the present invention may be used for the production of various articles, such as e.g. molded articles and/or extruded articles. The term “molded article” (or “extruded article”) as used in the present invention comprises articles made according to a molding process (or an extrusion process). A “molded article” (or “extruded article”) can also be part of another object.

A molded article, such as a frame for stereoscopic selection devices or glasses, comprises a biodegradable composition, which biodegradable composition comprises between 40 and 97% by weight of poly(lactic acid) polymer, and between 0.5 and 35% by weight of co-polyester polymer with adipic acid, each on the basis of the total weight of the biodegradable composition. In particular, a biodegradable composition for a molded article can comprise between 50 and 85% by weight of poly(lactic acid) polymer, and especially between 55 and 82% by weight of poly(lactic acid) polymer, in particular between 2 and 20% by weight of co-polyester polymer with adipic acid, and especially between 4 and 17% by weight of co-polyester polymer with adipic acid, each on the basis of the total weight of the biodegradable composition. As outlined in detail before, the composition for the preparation of such molded articles can comprise in addition to the above-mentioned components mineral particles comprising at least one of magnesium, and silicon, organic peroxide(s), mono ester(s), and/or natural plasticizer(s).

When preparing an injection molding formulation, such as the present stereoscopic selection devices, a composition may be used comprising between 80% and 97% by weight of poly(lactic acid) polymer, between 2% and 10% by weight of co-polyester polymer with adipic acid, and less than 5% by weight of mono ester, and more preferably between 82% and 95% by weight of poly(lactic acid) polymer, between 3% to 8% by weight of co-polyester polymer with adipic acid, and between 0.1 and 4% by weight of mono ester, and most preferably between 85% and 90% by weight of poly(lactic acid) polymer, between 5% to 7% by weight of co-polyester polymer with adipic acid, and between 1 and 3% by weight of mono ester, each on the basis of the total weight of the biodegradable composition.

Alternatively, an injection molding formulation can comprise between 50% and 75% by weight of poly lactic acid polymer, between 5% and 15% by weight of co-polyester polymer with adipic acid, between 10% and 30% by weight of mineral particles comprising at least one element selected from the group consisting of magnesium, and silicon, and less than 2% by weight of organic peroxide, more preferably between 55% and 70% by weight of poly lactic acid polymer, between 8% and 12% by weight of co-polyester polymer with adipic acid, between 15% and 25% by weight of mineral particles comprising at least one element selected from the group consisting of magnesium, and silicon, and between 0.1 and 1.8% by weight of organic peroxide, and most preferably between 58% and 67% by weight of poly lactic acid polymer, between 9% and 11% by weight of co-polyester polymer with adipic acid, between 18% and 22% by weight of mineral particles comprising at least one element selected from the group consisting of magnesium, and between 0.5 and 1.0% by weight of organic peroxide, each on the basis of the total weight of the biodegradable composition.

In addition, the design may include producing an article, such as biodegradable stereoscopic eyewear frames, comprising a biodegradable composition, said process comprising providing a biodegradable composition comprising between 40 and 97% by weight of poly(lactic acid) polymer, and between 0.5 and 35% by weight of co-polyester polymer with adipic acid, each on the basis of the total weight of the biodegradable composition, and subjecting said biodegradable composition to injection molding.

Injection molding is a process known to a skilled person and are described for example in Modern Plastics Encyclopedia, McGraw-Hill, Inc., mid-October 1991 edition.

Two examples of injection molding are provided, again taken from the examples provided in U.S. Pat. No. 7,138,439.

### Injection Molding Formulation 1

An injection molding formulation is prepared which comprising 94% by weight poly(lactic acid) polymer 5% by weight (co-polyester polymer with adipic acid) 1% by weight Zinc stearate.

The above-mentioned compounds are mixed by means of extrusion compounding at a temperature of 160° C. during about 2 to 10 minutes The resulting mixture is filled in a injection molding device at a temperature of about 160° C. and is injected into a mold at a temperature of about 20° C. in order to obtain an injection molded cup.

### Injection Molding Formulation 2

An injection molding formulation is prepared which comprises 74.5% by weight poly (lactic acid) polymer 5% by weight (co-polyester polymer with adipic acid) 20% by weight of magnesium silicate 0.5% by weight of 2,5-Dimethyl-2,5-di(t-butyl peroxy)hexane.

The injection molding formulation is prepared as detailed in Injection Molding Formulation 1 and injection molded products may be obtained according to the steps lined out in Injection Molding Formulation 1.

While Cereplast is contemplated in the present design, other biodegradable plastic-like compounds or resins may be employed, including but not limited to Natur-Tec bioplastics, available from Northern Technologies International Corporation of Circle Pines, Minn., and products available from Metabolix, Inc. of Cambridge, Mass. Other similar biodegradable products may be usable in the present design. The present design may be completely fashioned from biodegradable materials, and it is preferable for the design to be fabricated from 100 percent biodegradable materials, but the eyewear (temple pieces and frame piece) may also substantially include biodegradable materials, where substantially in this context means in excess of, for example, 25 or 50 percent biodegradable materials.

Injection molding in the current design comprises injection molding of the temple pieces 103 and 104 and the frame piece 105. Typically, a hinge may be formed in the joint between each temple piece and the frame piece, and in the present design, it is contemplated that such a hinge be formed using the plastic material rather than using, for example, a metal hinge. Formation of such a hinge may include forming a coupling joint whereby one portion, such as the temple piece, includes a “male” component while the receiving component, such as the frame piece, includes a “female” component, or vice versa. In this manner, a hinged joint may be created that employs a biodegradable, injection molding material. Other hinge configurations that employ only front and temple piece moldings may be employed.

Disposal of the eyewear may occur as follows. Upon completion of the stereoscopic movie, eyewear may be collected at the theater, such as by patrons placing eyewear in a bin. The eyewear may be transported to a central processing facility to wash and inspect the eyewear and determine which eyewear can be reused. The reusable eyewear may be re-bagged and the eyewear put back into inventory to be sent to the theaters for future use. Inspection for reuse may prove too costly and the most economical procedure may be to simply process all of the eyewear as biodegradable. Eyewear inspection is not relevant to the teachings herein.

For those frames that are unacceptable, the present biodegradable stereoscopic eyewear frames are compostable or can be disposed of using other green techniques. However, given that the state of the art lenses or sheet polarizing filters are not biodegradable, such lenses or filters should preferably be separated from the frames and preferably recycled in some manner. It is a common practice in the manufacture of stereoscopic eyewear with plastic frames to use a gluing or a welding process to stake or seal the lenses to the frames. This allows for the guaranteed location of the lenses so that their polarizing axes cannot be rotated and stay fixed. This is an important aspect of frame and lens manufacture and allows the eyewear to meet specification with regard to image selection so that the highest quality stereoscopic image may be seen. As a result, it is desirable to separate the glued-in lenses from the frames since only the frames are biodegradable.

Separation of the two components (frames and lenses) occurs by initially collecting the eyewear from the theater and transporting the eyewear to, for example, a central location. The eyewear may be placed in a large tank filled with water plus, in certain cases, an accelerant (enzyme or other appropriate chemical that results in a biodegradable combination). Heating may be required in some cases in an effort to accelerate decomposition of the frames. An enzyme or other type of accelerant known to the industry may be added to the warm-water medium before or after addition of water. After a time, the frames become a slurry of biodegradable material with intact polarizing filters in the slurry.

The solid polarization filters may be readily separated from the slurry. Since the specific gravity of the frame material is much greater than that of the lenses, the frame slurry propagates to the bottom of the tank, or simply fills the tank as a liquefied medium. The lenses, due to the specific gravity of polarizing lenses or filters, “float” on the slurry or rise to the top of the slurry and are skimmed from the surface of the tank by any means, generally known to those skilled in the art. Alternately, the material is run through a strainer or a sieve, or a collection device is placed in the tank, such as a strainer positioned at the bottom of the tank. The strainer is gradually raised, the slurry of biodegradable material passes through the strainer, and the polarizing filters are left intact to be disposed of as non-biodegradable material. The biodegradable material is then moved to a landfill.

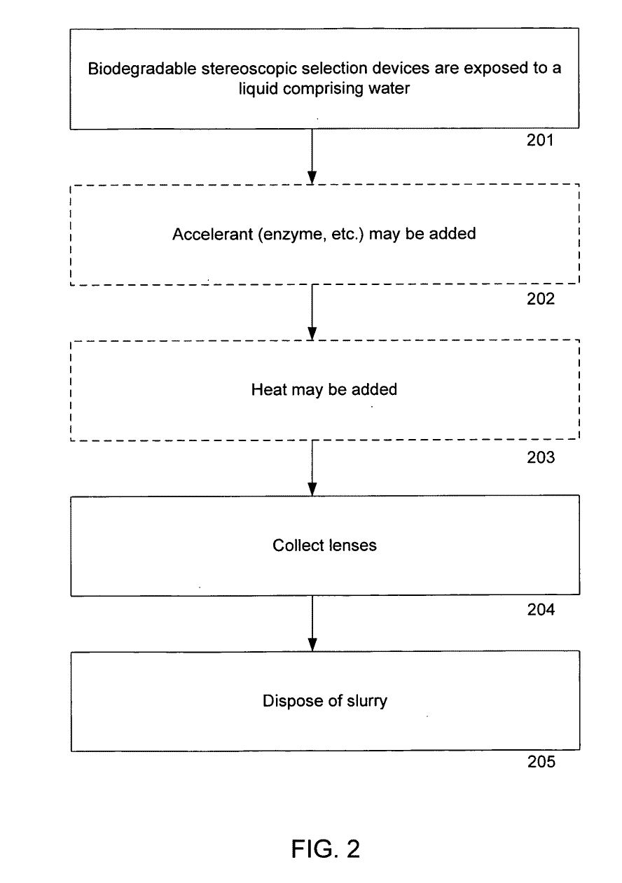

FIG. 2 illustrates general components of the method for disposal. From FIG. 2, the biodegradable stereoscopic selection devices are exposed at point 201 to a liquid typically comprising water. Degradation of the frames in the liquid is awaited until a slurry is formed. As shown at point 202, an accelerant (enzyme, etc.) may be added, and at point 203 heat may be added. At point 204, the lenses are collected, by skimming them from the top of the slurry, straining the slurry containing the lenses, or using other appropriate techniques as described. At point 205, the slurry formed by the frames in the liquid is disposed.

This process will ensure the eyewear will not have a one time only use and will extend the life of the product as long as possible. For those units that cannot be reused, the lenses may be removed and the frames will then be taken to a local compost facility. The lenses may be ground up for filler uses as is the case currently with plastic materials.

Some theater owners may wish to manage the reuse process themselves. Since a lot of the trash in a theater is organic, food scraps and the like, the presence of such biodegradable materials may induce the theater owners to develop a complete biodegradable solution to include their trash that is now hauled to the city dump, in addition to the biodegradable eyewear.

Theaters may also recycle paper trash or employ a biodegradable material for beverages, popcorn and other food containers. Announcements can be made at the theater, or a paper tag, made from recycled materials, can be included that tells the patron to take the product home and conduct a sort of experiment to observe how the eyewear biodegrades.

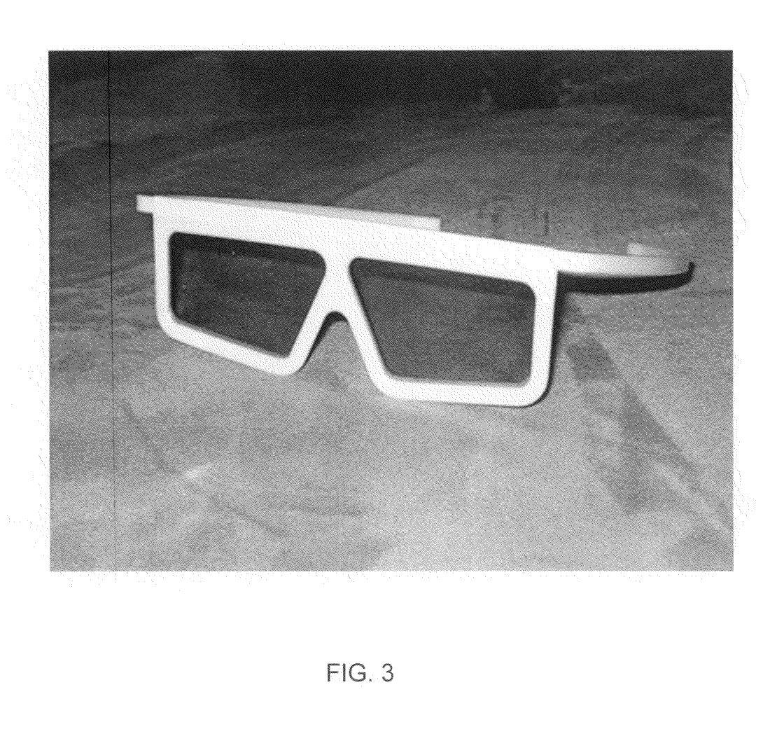

FIG. 3 illustrates one embodiment of the present design, including frames composed of biodegradable material.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A stereoscopic image receiving device comprising:
a front frame piece configured to maintain two stereoscopic lenses, the front piece substantially constructed of biodegradable materials; and
a pair of temple pieces, each temple piece connectable to the front frame piece at an end thereof, each temple piece substantially constructed of biodegradable materials.

2. The stereoscopic image receiving device of claim 1, wherein the front frame piece has formed therein a portion of a hinge, and each temple piece has a corresponding hinge portion formed therein.

3. The stereoscopic image receiving device of claim 1, wherein the front frame piece and the pair of temple pieces are formed using injection molding techniques.

4. The stereoscopic image receiving device of claim 1, wherein each temple piece and the frame piece are completely formed of biodegradable materials.

5. The stereoscopic image receiving device of claim 1, wherein each temple piece and the frame piece are substantially formed of Cereplast.

6. The stereoscopic image receiving device of claim 1, wherein the frame piece is releasable from the stereoscopic lenses by liquefying the frame piece and forming a biodegradable slurry.

7. A method for recycling biodegradable stereoscopic selection devices comprising frames fashioned of biodegradable materials and lenses, the method comprising:
exposing the biodegradable stereoscopic selection devices to a liquid comprising water and awaiting degradation of the frames fashioned of biodegradable materials in the liquid until a slurry is formed;
collecting the lenses; and
disposing of the slurry formed by the frames fashioned of biodegradable materials in the liquid.

8. The method of claim 7, wherein the liquid further comprises an accelerant.

9. The method of claim 7, wherein collecting the lenses comprises collecting the lenses floating on top of the slurry.

10. The method of claim 7, wherein said exposing also comprises heating the liquid.

11. A stereoscopic image receiving device comprising:
a front frame piece configured to maintain two stereoscopic lenses, the front piece substantially constructed of biodegradable materials; and
a pair of temple pieces, each temple piece connectable to the front frame piece at an end thereof, each temple piece substantially constructed of biodegradable materials;
wherein the front frame piece is joined to the pair of temple pieces by joints substantially formed in at least one of the front piece and two temple pieces of biodegradable materials, wherein said joints are free of non-biodegradable materials.

12. The stereoscopic image receiving device of claim 11, wherein the front frame piece has formed therein a portion of a hinge, and each temple piece has a corresponding hinge portion formed therein.

13. The stereoscopic image receiving device of claim 11, wherein the front frame piece and the pair of temple pieces are formed using injection molding techniques.

14. The stereoscopic image receiving device of claim 11, wherein each temple piece and the frame piece are completely formed of biodegradable materials.

15. The stereoscopic image receiving device of claim 11, wherein each temple piece and the frame piece are substantially formed of Cereplast.

16. The stereoscopic image receiving device of claim 11, wherein the frame piece is releasable from the stereoscopic lenses by liquefying the frame piece and forming a biodegradable slurry.
